(19) United States
(12) Patent Application Publication
(10) Pub. No.: US 2024/0062515 A1
(43) Pub. Date: Feb. 22, 2024

(54) METHOD FOR CLASSIFICATION USING DEEP LEARNING MODEL

(71) Applicant: VUNO Inc., Seoul (KR)

(72) Inventors: Hyunwoo OH, Seoul (KR); Sejin PARK, Yongin-si (KR); Eunpyeong HONG, Seongnam-si (KR); Dongsoo LEE, Seoul (KR)

(21) Appl. No.: 18/260,461

(22) PCT Filed: Nov. 9, 2021
(86) PCT No.: PCT/KR2021/016196

§ 371 Date: Jul. 5, 2023

(30) Foreign Application Priority Data
Jan. 6, 2021 (KR) 10-2021-0001606

(51) Int. Cl. G06V 10/764; G06N 3/042; G06N 3/045; G06T 7/00; G06V 10/40; G06V 10/766; G06V 10/776; G06V 10/82

(52) U.S. Cl. CPC G06V 10/764; G06N 3/042; G06N 3/045; G06T 7/0012; G06V 10/40; G06V 10/766; G06V 10/776; G06V 10/82; G06T 2207/20081; G06T 2207/20084; G06T 2207/30016; G06V 2201/031

(57) ABSTRACT

According to an exemplary embodiment of the present disclosure, a method for classification by using a deep learning model, the method being performed by a computing device, is disclosed. The method may include: extracting a feature vector interpretable based on domain knowledge by inputting an image including at least one object of interest into a first neural network of a deep learning model; and estimating a probability value corresponding to a classification task by inputting the feature vector into a second neural network of the deep learning model. In this case, the deep learning model may be pre-trained based on a loss function having an output value of the first neural network and an output value of the second neural network as input variables.

### BACKGROUND

### Technical Field

The present disclosure relates to an image analysis method, and more particularly to a method of performing a classification task by using a deep learning model that has been regularized to be interpretable by humans while improving performance.

### Description of the Related Art

Computer vision and deep learning technologies are experiencing rapid growth. Despite this growth, many of the deep learning techniques being explored to date suffer from the problem that it is mostly difficult to interpret the basis for the determination of the models. Because of these shortcomings, deep learning models are sometimes referred to as black boxes.

Even when deep learning models achieve high performance during a validation process, there is always the possibility of unexpected behavior. Therefore, there is a huge risk in completely trusting deep learning models. To minimize this risk, it is necessary for humans to be able to interpret the decision-making process and basis behind a deep learning model's judgment. In other words, the explanation possibility of deep learning models is becoming an increasingly important issue in the field of artificial intelligence.

The above issues are among the most active research topics in medical artificial intelligence. The explanation possibility of deep learning models in medical artificial intelligence is being actively studied by using a post hoc approach. Most studies use a post hoc analysis approach that utilizes an attention map to represent the areas that contributed most to the model's predictions. However, post hoc analysis methods that utilize attention maps have the limitation that they only provide basis to explain the output value of the deep learning model itself, but still do not provide the type of decision-making framework based on which the deep learning model derived the output value.

Korean Patent No. 10-2142205 (Jul. 31, 2020) discloses an explainable artificial intelligence modeling and simulation system.

### BRIEF SUMMARY

### Technical Problem

The present disclosure is conceived in response to the foregoing background art, and aims to provide a regularization technique for improving the interpretation and performance of deep learning models, and a method for performing a classification task by using a model to which the aforementioned technique is applied.

### Technical Solution

An exemplary embodiment for implementing the foregoing technical problem provides a method for classification by using a deep learning model, the method being performed by a computing device. The method may include: extracting a feature vector interpretable based on domain knowledge by inputting an image including at least one object of interest into a first neural network of a deep learning model; and estimating a probability value corresponding to a classification task by inputting the feature vector into a second neural network of the deep learning model. In this case, the deep learning model may be pre-trained based on a loss function having an output value of the first neural network and an output value of the second neural network as input variables.

In an alternative exemplary embodiment, the feature vector may include a feature in a form interpretable based on the domain knowledge in relation to a characteristic of the object of interest that affects the classification task of the deep learning model.

In the alternative exemplary embodiment, the loss function may include: a first loss function having the probability value estimated by the second neural network as an input variable; and a second loss function having the feature vector extracted by the first neural network as an input variable.

In the alternative exemplary embodiment, the loss function may be expressed as a sum of a first loss function used for the classification task and a second loss function used for a regression task.

In the alternative exemplary embodiment, the second loss function may be subject to a regularization factor. In this case, a size of the regularization factor may vary based on a learning cycle (epoch) to adjust a relative weight between the first loss function and the second loss function. Further, a size of the regularization factor may decrease until the number of times of repetition of a learning cycle reaches a predetermined reference.

In the alternative exemplary embodiment, the first loss function may include a cross-entropy loss function. Further, the second loss function may include a hyperbolic log loss function.

In the alternative exemplary embodiment, the extracting of the feature vector may include: extracting an image patch including at least one brain subregion from a medical image including a brain region; and inputting the image patch into the first neural network of the deep learning model to generate a feature vector corresponding to the brain subregion.

In the alternative exemplary embodiment, the feature vector may include a feature in a form interpretable based on the domain knowledge in relation to a characteristic of the brain region including at least one of volume, shape, length, or texture of the brain subregion.

In the alternative exemplary embodiment, the estimating of the probability value may include inputting the feature vector corresponding to the brain subregion into the second neural network of the deep learning model to estimate a probability value regarding the presence of the brain disease.

Another exemplary embodiment for implementing the foregoing technical problem provides a computer program stored in a computer-readable storage medium. When the computer program is executed in one or more processors, the computer program causes a deep learning model to perform following operations to perform classification, the operations include: an operation of extracting a feature vector interpretable based on domain knowledge by inputting an image including at least one object of interest into a first neural network of a deep learning model; and an operation of estimating a probability value corresponding to a classification task by inputting the feature vector into a second neural network of the deep learning model. In this case, the deep learning model may be pre-trained based on a loss function having an output value of the first neural network and an output value of the second neural network as input variables.

Another exemplary embodiment for implementing the foregoing technical problem provides a computing device performing classification by using a deep learning model. The computing device includes: a processor including at least one core; and a memory including program codes executable by the processor; and a network unit for receiving an image, in which the processor may extract a feature vector interpretable based on domain knowledge by inputting an image including at least one object of interest into a first neural network of a deep learning model, and estimate a probability value corresponding to a classification task by inputting the feature vector into a second neural network of the deep learning model. In this case, the deep learning model may be pre-trained based on a loss function having an output value of the first neural network and an output value of the second neural network as input variables.

### Advantageous Effects

The present disclosure may provide a regularization technique for improving the interpretation and performance of deep learning models, and a method for performing a classification task by using a model to which the aforementioned technique is applied.

### BRIEF DESCRIPTION OF THE SEVERAL VIEWS OF THE DRAWINGS

FIG. 1 is a block diagram of a computing device for performing classification by using a deep learning model according to an embodiment of the present disclosure.

FIG. 2 is a schematic diagram illustrating a network function according to the exemplary embodiment of the present disclosure.

FIG. 3 is a block diagram illustrating a process for performing classification of a computing device according to the embodiment of the present disclosure.

FIG. 4 is a conceptual diagram illustrating a brain disease prediction process by using a deep learning model of the computing device according to the embodiment of the present disclosure.

FIG. 5 is a flowchart of a classification method using a deep learning model according to an embodiment of the present disclosure.

FIG. 6 is a flowchart of a method for predicting brain disease by using a deep learning model according to the embodiment of the present disclosure.

FIG. 7 is a schematic diagram of a computing environment according to the exemplary embodiment of the present disclosure.

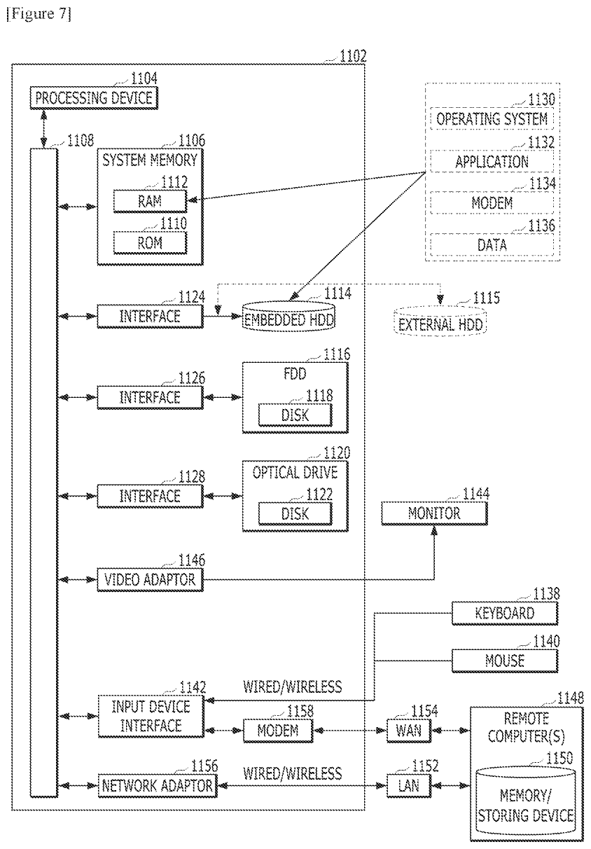

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component,” “module,” “system,” and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Further, a term “or” intends to mean comprehensive “or” not exclusive “or.” That is, unless otherwise specified or when it is unclear in context, “X uses A or B” intends to mean one of the natural comprehensive substitutions. That is, in the case where X uses A; X uses B; or, X uses both A and B, “X uses A or B” may apply to either of these cases. Further, a term “and/or” used in the present specification shall be understood to designate and include all of the possible combinations of one or more items among the listed relevant items.

Further, a term “include” and/or “including” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Further, the term “at least one of A and B” should be interpreted to mean “the case including only A,” “the case including only B,” and “the case where A and B are combined.”

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, a network function, an artificial neural network, and a neural network may be interchangeably used.

In the meantime, the term “image” or “image data” used throughout the detailed description and the claims of the present disclosure refer to multidimensional data composed of discrete image elements (for example, pixels in a 2-dimensional image), and in other words, is the term referring to a target visible to the eye (for example, displayed on a video screen) or a digital representation of the target (for example, a file corresponding to a pixel output of a CT or MRI detector).

For example, “image” or “picture” may be a medical image of a subject collected by Computed Tomography (CT), Magnetic Resonance Imaging (MRI), ultrasonic rays, or other predetermined medical imaging systems publicly known in the art of the present disclosure. The image is not necessarily provided in a medical context, but may also be provided in a non-medical context, such as X-ray imaging for security screening.

Throughout the detailed description and the claims of the present disclosure, the “Digital Imaging and Communications in Medicine (DICOM)” standard is a term collectively referring to various standards used in digital imaging expression and communication in medical devices, and the DICOM standard is published by the allied committee formed by the American College of Radiology (ACR) and American National Electrical Manufacturers Associations (NEMA).

Further, throughout the detailed description and the claims of the present disclosure, a “Picture Archiving and Communication System (PACS)” is a term that refers to a system that stores, processes, and transmits images in accordance with the DICOM standard, and medical images obtained by using digital medical imaging equipment, such as X-ray, CT, and MRI, may be stored in the DICOM format and transmitted to terminals inside and outside a hospital through a network, and a reading result and a medical record may be added to the medical image.

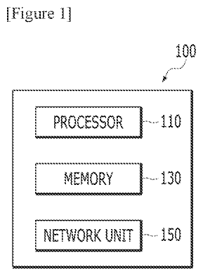

FIG. 1 is a block diagram of a computing device for performing classification by using a deep learning model according to an embodiment of the present disclosure.

A configuration of the computing device 100 illustrated in FIG. 1 is only an example simplified and illustrated. In an exemplary embodiment of the present disclosure, the computing device 100 may include other components for performing a computing environment of the computing device 100, and only some of the disclosed components may constitute the computing device 100.

The computing device 100 may include a processor 110, a memory 130, and a network unit 150.

The processor 110 may be constituted by one or more cores, and include processors for data analysis and deep learning, such as a central processing unit (CPU), a general purpose graphics processing unit (GPGPU), a tensor processing unit (TPU), etc., of the computing device. The processor 110 may read a computer program stored in the memory 130 and process data for machine learning according to an exemplary embodiment of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process learning of the network function. For example, the CPU and the GPGPU may process the learning of the network function and data classification using the network function jointly. In addition, in an exemplary embodiment of the present disclosure, the learning of the network function and the data classification using the network function may be processed by using processors of a plurality of computing devices together. In addition, the computer program performed by the computing device according to an exemplary embodiment of the present disclosure may be a CPU, GPGPU, or TPU executable program.

According to an embodiment of the present disclosure, the processor 110 may perform a classification task based on an image containing at least one object of interest by using a pre-trained deep learning model. In this context, a classification task may be understood as the task of predicting or determining the class of a state, attribute, characteristic, and the like of an object of interest. For example, the processor 110 may make a prediction about the presence of Alzheimer's disease based on a medical image that includes at least one brain region by using a pre-trained deep learning model. The processor 110 may input medical images including at least one brain region into a deep learning model to determine whether the subject is currently suffering from Alzheimer's disease or is in a normal state.

The deep learning model used by the processor 110 may include a first neural network for extracting a feature vector based on an image including at least one object of interest, and a second neural network for estimating a probability value corresponding to a classification task based on the feature vector derived from the first neural network. In this case, the first neural network of the deep learning model may include a convolutional neural network optimized for extracting a feature vector from the image. The second neural network may include a fully-connected neural network that is connected to the convolutional neural network to produce an output value suitable for the classification task. For example, a deep learning model may include a first neural network that extracts a feature vector based on a medical image including at least one object of interest, and a second neural network that estimates a probability value of the presence of Alzheimer's disease based on the feature vector derived from the first neural network. The first neural network may include a convolutional neural network that receives at least a portion of a three-dimensional Magnetic Resonance (MR) image as input to generate a feature vector. The second neural network may include a fully-connected neural network that receives auxiliary information, such as the gender and age of the subject, together with the feature vector as input to generate a probability value regarding the presence of Alzheimer's disease. The neural networks included in the deep learning model of the present disclosure may include many types of neural networks suitable for classification tasks in the field of computer vision, in addition to those described above.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to the exemplary embodiment of the present disclosure may use a predetermined form of a publicly known wired/wireless communication system.

The network unit 150 may receive an image depicting an object of interest determined by the classification task from an external system. For example, the network unit 150 may receive a medical image in which a body organ is represented from a medical image storage and transmission system. The medical image with representations of body organs may be data for training or inference of the neural network model trained with two-dimensional or three-dimensional features. The medical image in which the organ of the body is expressed may be the three-dimensional T1 MR image including at least one brain region. The medical image in which the organ of the body is expressed is not limited to the foregoing example, and may include all of the images, such as X-ray images and CT images, related to the organ of the body obtained through the photographing.

Further, the network unit 150 may transceive information processed by the processor 110, the user interface, and the like with other terminals through communication. For example, the network unit 150 may provide the user interface generated by the processor 110 to a client (for example, a user terminal). Further, the network 150 may receive the external input of the user applied to the client and transmit the received external input to the processor 110. In this case, the processor 100 may process the operations of output, correction, change, addition, and the like of the information provided through the user interface based on the external input of the user received from the network unit 150.

In the meantime, the computing device 100 according to the exemplary embodiment of the present disclosure is a computing system for transceiving information with the client through communication and may include a server. In this case, the client may be a predetermined form of terminal accessible to the server. For example, the computing device 100 that is the server may receive a medical image from a medical image photographing terminal and predict a disease, and provide the user terminal with the user interface including the result of the prediction. In this case, the user terminal may output the user interface received from the computing device 100 that is the server, and input or process information through interaction with the user.

In an additional exemplary embodiment, the computing device 100 may also include a predetermined form of terminal which receives data resources generated in a predetermined server and performs additional information processing.

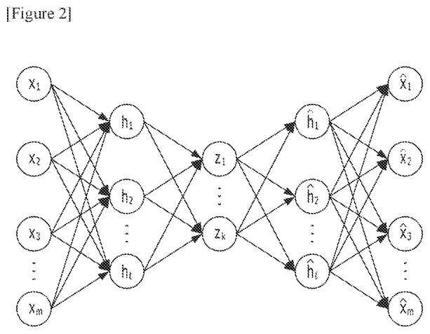

FIG. 2 is a schematic diagram illustrating a network function according to the embodiment of the present disclosure.

Throughout the present specification, the meanings of a calculation model, a nerve network, the network function, and the neural network may be interchangeably used. The neural network may be formed of a set of interconnected calculation units which are generally referred to as “nodes.” The “nodes” may also be called “neurons.” The neural network consists of one or more nodes. The nodes (or neurons) configuring the neural network may be interconnected by one or more links.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node data may be determined based on data input to the input node. Herein, a link connecting the input node and the output node may have a weight. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and weights set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer on the basis of distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node may mean nodes configuring the neural network, not the initial input node and the final output node.

In the neural network according to the embodiment of the present disclosure, the number of nodes of the input layer may be the same as the number of nodes of the output layer, and the neural network may be in the form that the number of nodes decreases and then increases again from the input layer to the hidden layer. Further, in the neural network according to another embodiment of the present disclosure, the number of nodes of the input layer may be smaller than the number of nodes of the output layer, and the neural network may be in the form that the number of nodes decreases from the input layer to the hidden layer. Further, in the neural network according to another embodiment of the present disclosure, the number of nodes of the input layer may be larger than the number of nodes of the output layer, and the neural network may be in the form that the number of nodes increases from the input layer to the hidden layer. The neural network according to another embodiment of the present disclosure may be the neural network in the form in which the foregoing neural networks are combined.

A deep neural network (DNN) may mean the neural network including a plurality of hidden layers, in addition to an input layer and an output layer. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a Long Short-Term Memory (LSTM), a transformer, a restricted Boltzmann machine (RBM), a deep belief network (DBN), a Q network, a U network, a Siamese network, a Generative Adversarial Network (GAN), and the like. The foregoing description of the deep neural network is merely illustrative, and the present disclosure is not limited thereto.

In the embodiment of the present disclosure, the network function may include an auto encoder. The auto encoder may be one type of artificial neural network for outputting output data similar to input data. The auto encoder may include at least one hidden layer, and the odd-numbered hidden layers may be disposed between the input/output layers. The number of nodes of each layer may decrease from the number of nodes of the input layer to an intermediate layer called a bottleneck layer (encoding), and then be expanded symmetrically with the decrease from the bottleneck layer to the output layer (symmetric with the input layer). The auto encoder may perform a nonlinear dimension reduction. The number of input layers and the number of output layers may correspond to the dimensions after preprocessing of the input data. In the auto encoder structure, the number of nodes of the hidden layer included in the encoder decreases as a distance from the input layer increases. When the number of nodes of the bottleneck layer (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer to an input layer of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the training of the neural network, the training data may be generally a subset of actual data (that is, data to be processed by using the trained neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of inactivating a part of nodes of the network during the training process, a method using a bath normalization layer, and the like may be applied.

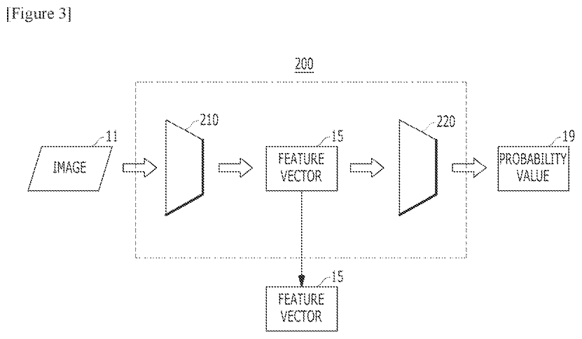

FIG. 3 is a block diagram illustrating a process for performing classification of a computing device according to the embodiment of the present disclosure.

Referring to FIG. 3, the processor 110 of the computing device 100 according to the embodiment of the present disclosure may input an image 11 including at least one object of interest into the first neural network 210 of the deep learning model 200 to extract a feature vector interpretable 15 based on domain knowledge. In this case, the feature vector 15, which is interpretable based on domain knowledge, is a judgmental basis for describing the decision-making process of the deep learning model 200 suitable for the classification task, and may be understood as a form of information that is interpretable by humans who are domain experts. Thus, the feature vector 15 may include information related to characteristic of the object of interest that affect the classification task of the deep learning model 200. In other words, the feature vector 15 may provide an explanation possibility to a human who is a domain expert, of how the deep learning model 200 performs the classification task by considering which characteristics of the object of interest. Such a human-interpretable feature vector 15 may be extracted and generated when the deep learning model 200 trained based on a loss function which is to be described later is used.

The processor 110 may input a feature vector 15 derived from a first neural network 210 into a second neural network 220 of the deep learning model 200 to estimate a probability value 19 corresponding to the classification task. Although not illustrated in FIG. 3, the processor 110 may also input auxiliary information required for the classification task together with the feature vector 15 into the second neural network 220 to generate the probability value 19 based on the classification task. In this case, the probability value 19 generated by the second neural network 220 is an output value that meets the purpose of the classification task, and may be understood as information representing a class for states, attributes, characteristics, and the like regarding the object of interest.

Meanwhile, the deep learning model 200 may be trained based on a loss function that takes an output value of the first neural network 210 and an output value of the second neural network 220 as input variables. The deep learning model 200 may be pre-trained by using a loss function that takes a feature vector that is the output value of the first neural network 210 and a predicted value based on the classification task that is the output value of the second neural network 220 as input variables. For example, based on supervising learning, the deep learning model 200 may perform training to increase the interpretability of the feature vector by computing and reducing a difference between the feature vector generated by the first neural network 210 and a guide vector in a human interpretable form by using the foregoing loss function. In addition, the deep learning model 200 may compute and reduce a difference between the predicted value generated by the second neural network 220 and a correct answer by using the foregoing loss function, thereby learning to derive results that meet the purpose of the classification task.

The loss function according to the embodiment of the present disclosure may include a first loss function that has a probability value estimated through the second neural network 220 as an input variable and a second loss function that has a feature vector extracted through the first neural network 210 as an input variable. For example, the loss function may be expressed as the sum of a first loss function and a second loss function to which a regularization factor is applied. When it is assumed that the feature vector output by the first neural network 210 is vₑ, the guide vector in the human interpretable form is yₑ, the output of the second neural network 220 is v_{c}, and the correct answer of the classification task is yₑ, the loss function may be expressed as [Equation 1].

LOSS=f(v_{c},y_{c})+γλg(vₑ,yₑ) [Equation 1]

In this case, f(v_{c}, y_{c}) represents the first loss function, g(vₑ, yₑ) denotes the second loss function, and γ denotes the regularization factor.

The loss function of the form expressed as [Equation 1] may cause the feature vector, which is the output value of the first neural network 210, to have both implicitness to optimize the performance of the classification task by preventing overfitting of the deep learning model 200 and explicitness to indicate an explanation possibility for the decision-making process of the deep learning model 200. In other words, the loss function expressed as the sum of the first loss function and the second loss function to which the regularization factor is applied may ensure the interpretability of the feature vector, which is the intermediate output value of the deep learning model 200, and increase the classification performance of the deep learning model 200.

Specifically, the first loss function may include a loss function used in the classification task. The first loss function is a function for computing a difference between a probability value output from the second neural network 220 and a correct answer based on the classification task. For example, the first loss function may be a cross-entropy loss function. The second loss function may include a loss function used in a regression task. The second loss function is a function for computing the difference between the feature vector output from the first neural network 210 and the guide vector in a human interpretable form. For example, the second loss function may be a hyperbolic log loss function such as the following [Equation 2].

$$\\ \begin{matrix}g ( v , y ) = {\sum }_{i = 0}^{n} log ( cosh ( {y}_{i} - {v}_{i} ) ) & [ Equation 2 ]\end{matrix}$$

In this case, n represents the length of the feature vector vₑ.

Meanwhile, a regularization factor may be applied to the second loss function to adjust the relative weight between the first loss function and the second loss function, as illustrated in [Equation 1]. In order to enhance the classification ability of the deep learning model 200 along with securing a feature vector interpretable based on domain knowledge, the size of the regularization factor may be varied based on a learning cycle. For example, at the beginning of learning, the loss function to which a regularization factor of a predetermined size is applied to the second loss function may be used to ensure the explanation possibility of the deep learning model. However, as the learning progresses, the size of the regularization factor may be gradually reduced until the number of learning cycles reaches a predetermined reference (for example, the number of times of learning cycles defined by a certain value), as it is ultimately necessary not only to ensure the explanation possibility of the deep learning model, but also to optimize the performance of the classification task of the deep learning model. The predetermined reference may be predetermined based on the accuracy of the output of the deep learning model. By gradually changing the learning objective for the feature vector from explicitness to implicitness through such a gradual reduction in the size of the regularization factor, it is possible to improve the classification performance of the deep learning model 200 while obtaining a feature vector interpretable from the deep learning model 200 based on the domain knowledge.

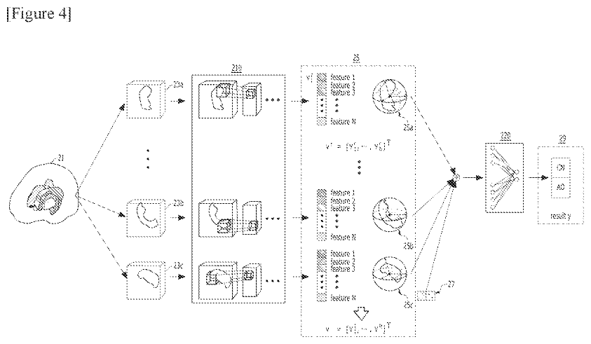

FIG. 4 is a conceptual diagram illustrating a brain disease prediction process by using a deep learning model of the computing device according to the embodiment of the present disclosure. Referring to FIG. 4, a process for performing a classification task to predict Alzheimer's disease based on a three-dimensional T1 MR image will be described in accordance with an embodiment of the present disclosure.

Referring to FIG. 4, the processor 110 of the computing device 100 according to the embodiment of the present disclosure may change the size of the voxel configuring the three-dimensional MR image including a plurality of brain regions to match the input size of the first neural network 210. The processor 110 may compartmentalize the three-dimensional MR image 21 in which the size of the voxel is adjusted into regions for each brain region by using a separate deep learning model for segmentation, to obtain brain region-specific masks. The processor 110 may extract three-dimensional image patches 23a, 23b, and 23c for predetermined brain regions that affect the early progression of Alzheimer's disease from the three-dimensional MR image 21 by using brain region-specific masks. Through the preprocessing of the three-dimensional MR image, it is possible to remove unnecessary information to improve the transparency of the deep learning model performing the classification task and stabilize the learning process by allowing the model to efficiently extract the desired features.

The processor 110 may input each of the three-dimensional image patches 23a, 23b, and 23c into the first neural network 210 to extract feature vectors 25a, 25b, and 25c for the image patches 23a, 23b, and 23c, respectively. In this case, the feature vectors 25a, 25b, and 25c may include features representing brain region-specific characteristics, such as volume (feature 1), length (feature 2, 3), surface area (feature N) for each brain region, and the like. The processor 110 may concatenate the feature vectors 25a, 25b, and 25c corresponding to the image patches 23a, 23b, and 23c, respectively, to generate one intermediate feature vector 25.

Although not illustrated in FIG. 4, a guide vector corresponding to each of the elements 25a, 25b, and 25c configuring the intermediate feature vector 25 may be utilized for learning the intermediate feature vector 25. Guide vectors are information in human-understandable form, consisting of features that describe the characteristics of each of the three-dimensional brain regions, such as volume, shape, length, or texture. For example, guide vectors may include radiomic features, which are one of the most widely used features in the medical field. Radiomic features may provide a human-understandable description of the shape of the object of interest present in a medical image. The processor 110 may induce the intermediate feature vector 25 to be represented in a human-understandable form, such as a radiomic feature through a process of minimizing the difference between the guide vector comprising the radiomic features and the intermediate feature vector 25 For the learning action, a loss function may be used that includes a first loss function used for the classification task and a second loss function used for regression task to which a regularization factor has been applied.

The processor 110 may input the feature vectors 25a, 25b, and 25c into the second neural network 220 to produce a probability value 29 indicating that the subject has Alzheimer's disease or is normal. In this case, the processor 110 may use the feature vectors 25a, 25b, and 25c as input to the second neural network 220, along with biometric information 27, such as the gender and age of the subject. In other words, the processor 110 may predict the probability of the presence of Alzheimer's disease by using both the biological information of the subject as well as the characteristics of the brain regions seen in the medical image. Although not illustrated in FIG. 4, the processor 110 may induce the probability value 29, which is the predicted result of the deep learning model, to be closer to the correct answer through a process of minimizing the difference between the probability value 29 and the correct answer value labeled on the training image. For the learning action, a loss function may be used that includes a first loss function used for the classification task and a second loss function used for regression task to which a regularization factor has been applied.

Table 1 below shows the results of a comparative validation to evaluate the validity of a deep learning model according to the embodiment of the present disclosure. For comparative validation, a first model based on a loss function of the form [Equation 1] to which a regularization factor is applied, a second model based on a loss function to which a regularization factor is not applied, and a third model based on the pyradiomics that are open sources were established.

TABLE 1

| Model | Accuracy | AUROC | Sensitivity | Specificity |
|---|---|---|---|---|
| First model | 0.8963 | 0.9298 | 0.9533 | 0.8276 |
| (γ application: ◯) | | | | |
| Second model | 0.7800 | 0.9132 | 0.8621 | 0.6897 |
| (γ application: X) | | | | |
| Third model | 0.8378 | 0.9094 | 0.9471 | 0.7222 |
| (pyradiomics) | | | | |

The performance evaluation for each model was based on four metrics. The four metrics are true positive, true negative, false positive, and false negative. It was derived the receiver operating characteristic curve (ROC curve) of each model using the four metrics, and calculated the accuracy, area under the receiver operating characteristic curve (AUROC), sensitivity, and specificity of each model based on the ROC curve.

Referring to [Table 1], it can be seen that the first model to which the loss function is applied according to the embodiment of the present disclosure yields significantly higher results than the other two models in terms of accuracy, AUROC, sensitivity, and specificity. In other words, it can be seen from Table 1 that the deep learning model to which a loss function is applied according to the embodiment of the present disclosure exhibits significantly improved performance on classification task compared to the existing deep learning model. Furthermore, it can be seen that the deep learning model to which the loss function is applied according to the embodiment of the present disclosure has a functional difference in that, unlike existing deep learning models, it can derive a feature vector that can explain the basis for the judgment of the model.

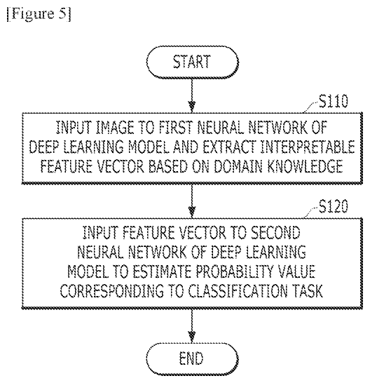

FIG. 5 is a flowchart of a classification method using a deep learning model according to an embodiment of the present disclosure.

Referring to FIG. 5, in operation S110, the computing device 100 according to the exemplary embodiment of the present disclosure may receive an image including at least one object of interest from an external system. The computing device 100 may input the image received from the external system into the first neural network of the deep learning model to extract a feature vector interpretable based on the domain knowledge. In this case, the deep learning model may be pre-trained based on a loss function expressed as the sum of a first loss function used in a classification task and a second loss function used in a regression task with a regularization factor applied to extract a feature vector interpretable based on domain knowledge. The regularization factor may be gradually reduced as the learning cycle is repeated to improve the classification performance of the model while ensuring the interpretability of the feature vector. The first neural network may be a convolutional neural network for extracting a feature vector from the image.

In operation S120, the computing device 100 may input the feature vector extracted from the first neural network into the second neural network of the deep learning model to produce a probability value that meets the purpose of the classification task. In this context, the classification task may be understood as a task of predicting classes associated with states, characteristics, and the like of objects of interest present in the image. The computing device 100 may use the feature vector extracted from the first neural network, as well as other auxiliary information that may be utilized in the classification task, as input data for the second neural network.

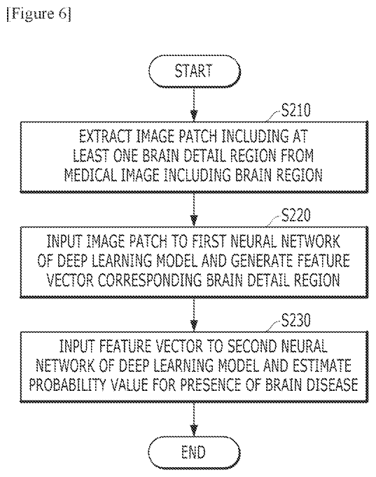

FIG. 6 is a flowchart of a method for predicting brain disease by using a deep learning model according to the embodiment of the present disclosure. Hereinafter, a process for performing a classification task for predicting brain disease based on medical images according to an embodiment of the present disclosure will be described with reference to FIG. 6.

Referring to FIG. 6, in operation S210, the computing device 100 may receive a medical image for predicting a brain disease from a medical image storing and transmitting system. The medical image for the prediction of brain disease may be three-dimensional MR images that include brain regions. The computing device 100 may process a three-dimensional MR image including a brain region to extract an image patch including at least one brain subregion (or brain detail region). In this case, the image patch may be extracted to fit the input size of the deep learning model.

In operation S220, the computing device 100 may input the image patch generated in operation S210 into the first neural network of the deep learning model to generate a feature vector corresponding to at least one brain subregion. In this case, the feature vector may include a feature in a form interpretable based on domain knowledge with respect to a characteristic of the brain region, including at least one of volume, shape, length, or texture of the brain subregion. In other words, the first neural network may generate feature vectors related to the characteristics of the brain regions based on which the deep learning model predicts Alzheimer's disease in a human-interpretable form of information. To generate the feature vector, the deep learning model may be pre-trained based on the loss function expressed as the sum of the first loss function, which is a cross-entropy function, and the second loss function, which is a hyperbolic log function. In this case, a regularization factor may be applied to the second loss function to adjust relative weight to the first loss function.

In operation S230, the computing device 100 may input the feature vector generated in operation S220 into the second neural network of the deep learning model to estimate a probability value regarding the presence of the brain disease. In addition, the computing device 100 may input biometric information, such as gender, age, and the like that assists in determining the brain disease, along with the feature vector generated in operation S220, into the second neural network to estimate a probability value regarding the presence of the brain disease. When the biometric information, such as gender and age, is utilized, variables that affect the prediction of brain disease may be considered, thereby improving the accuracy of the model's output.

In the meantime, according to an embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a calculation model, a nerve network, the network function, and the neural network may be used with the same meaning. Hereinafter, the terms of the calculation model, the nerve network, the network function, and the neural network are unified and described with a neural network. The data structure may include a neural network. Further, the data structure including the neural network may be stored in a computer readable medium. The data structure including the neural network may also include preprocessed data for processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may include the entirety or a predetermined combination of pre-processed data for processing by neural network, data input to the neural network, a weight of the neural network, a hyper parameter of the neural network, data obtained from the neural network, an active function associated with each node or layer of the neural network, and a loss function for training the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes.” The “nodes” may also be called “neurons.” The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network (in the present specification, weights and parameters may be used with the same meaning), Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

FIG. 8 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

As the described above, the relevant contents are described in the best mode for implementing the present disclosure.

The present disclosure may be used in computing devices and the like that perform classification using deep learning models.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for classification by using a deep learning model, the method being performed by a computing device including at least one processor, the method comprising:
extracting a feature vector interpretable based on domain knowledge by inputting an image including at least one object of interest into a first neural network of a deep learning model; and
estimating a probability value corresponding to a classification task by inputting the feature vector into a second neural network of the deep learning model,
wherein the deep learning model is pre-trained based on a loss function having an output value of the first neural network and an output value of the second neural network as input variables.

2. The method of claim 1, wherein the feature vector includes:
a feature in a form interpretable based on the domain knowledge in relation to a characteristic of the object of interest that affects the classification task of the deep learning model.

3. The method of claim 1, wherein the loss function includes:
a first loss function having the probability value estimated by the second neural network as an input variable; and
a second loss function having the feature vector extracted by the first neural network as an input variable.

4. The method of claim 1, wherein the loss function is expressed as a sum of a first loss function used for the classification task and a second loss function used for a regression task.

5. The method of claim 4, wherein:
the second loss function is subject to a regularization factor; and
a size of the regularization factor varies based on a learning cycle (epoch) to adjust a relative weight between the first loss function and the second loss function.

6. The method of claim 4, wherein:
the second loss function is subject to a regularization factor; and
a size of the regularization factor decreases until the number of times of repetition of a learning cycle reaches a predetermined reference.

7. The method of claim 4, wherein:
the first loss function includes a cross-entropy loss function; and
the second loss function includes a hyperbolic log loss function.

8. The method of claim 1, wherein the extracting of the feature vector includes:
extracting an image patch including at least one brain subregion from a medical image including a brain region; and
inputting the image patch into the first neural network of the deep learning model to generate a feature vector corresponding to the brain subregion.

9. The method of claim 8, wherein the feature vector includes a feature in a form interpretable based on the domain knowledge in relation to a characteristic of the brain region including at least one of volume, shape, length, or texture of the brain subregion.

10. The method of claim 8, wherein the estimating of the probability value includes:
estimating a probability value regarding a presence of a brain disease by inputting the feature vector corresponding to the brain subregion into the second neural network of the deep learning model.

11. A computer program stored in a computer-readable storage medium, the computer program causing a deep learning model to perform following operations to perform classification when the computer program is executed in one or more processors, the operations comprising:
an operation of extracting a feature vector interpretable based on domain knowledge by inputting an image including at least one object of interest into a first neural network of a deep learning model; and
an operation of estimating a probability value corresponding to a classification task by inputting the feature vector into a second neural network of the deep learning model,
wherein the deep learning model is pre-trained based on a loss function having an output value of the first neural network and an output value of the second neural network as input variables.

12. A computing device performing classification by using a deep learning model, the computing device comprising:
a processor including at least one core; and
a memory including program codes executable by the processor; and
a network unit for receiving an image,
wherein the processor:
extracts a feature vector interpretable based on domain knowledge by inputting an image including at least one object of interest into a first neural network of a deep learning model, and
estimates a probability value corresponding to a classification task by inputting the feature vector into a second neural network of the deep learning model, and
wherein the deep learning model is pre-trained based on a loss function having an output value of the first neural network and an output value of the second neural network as input variables.
